(19) United States
(12) Patent Application Publication
(10) Pub. No.: US 2006/0280541 A1
(43) Pub. Date: Dec. 14, 2006

(54) Printer and method for supporting a linerless label

(76) Inventor: Robert Edward Lass JR., Mundelein, IL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/443,791

(22) Filed: May 31, 2006

Related U.S. Application Data
(60) Provisional application No. 60/685,901, filed on May 31, 2005.

(51) Int. Cl. B41J 15/00

(52) U.S. Cl. 400/611

(57) ABSTRACT

The present invention provides an improved linerless label printer and an associated method for printing a linerless label wherein the printed label is supported in a cantilevered position by a blanket of air until removal. Linerless labels are those labels that are printed and used without conventional release paper or liners. The labels include a printable surface and an opposed adhesive surface. Various embodiments of the invention are directed to a linerless label printer comprising a platen roller for driving the linerless label from a print position to a removal position, a secondary roller disposed adjacent the platen roller for removing a partially-adhered linerless label from the platen roller, and a flow device for providing an air flow that buoyantly supports the linerless label generally above the secondary roller in the removal position. A backwinding media supply spindle may also be provided to remove partially adhered linerless media from the platen roller during backfeed operations.

### CROSS-REFERENCE TO RELATED APPLICATIONS

This application claims the benefit of U.S. Provisional Application No. 60/685,901, filed May 31, 2005, which is entitled “Printer and Method for Supporting a Linerless Label” and is incorporated by reference herein in its entirety.

### BACKGROUND OF THE INVENTION

1. Field of the Invention

This invention relates to electronic label printing, and more particularly relates to the electronic printing of linerless labels.

2. Description of Related Art

As with many other manufacturing pursuits, it is desirable to reduce the quantity of waste produced during label printing. Such waste reductions limit the negative environmental impact attributable to label printing processes and further reduce manufacturing costs. To this end, linerless labels were developed. Linerless labels are those labels that are printed and used without conventional release layers or liners. Liners are conventionally used to support pressure sensitive adhesive labels as they moved through a printer. Liners protect the adhesive surface of the label from environmental contaminants and also reduce the incidence of printer binding or jamming due to undesired adhesion of the labels to various printer components. Unfortunately, however, liners account for considerable waste as they are necessarily discarded as the labels are used.

FIG. 1 is a schematic illustration of a linerless label printing process according to the known prior art. The depicted process is performed within a conventional thermal printer system 10. The printer system 10 includes a thermal print head 30, a platen drive roller 20, and a linerless label supply 12. The linerless label supply 12 includes a continuous web of linerless label media 15 that is coated on one surface 18 with a pressure sensitive adhesive. The opposite surface of the linerless label media 15 is a printable surface 16. One or more idler rollers 14 may be provided to guide the label media 15 from the supply 12 to the platen roller 20. In some applications, spring loaded dancers, rollers, plates, rods, and the like (not shown) may be provided to maintain sufficient tension in the linerless label media 15. During one type of thermal printing, namely, thermal transfer printing, the printable surface 16 is configured to receive a pigment (e.g., resin, wax-resin, etc.) that is transferred from a ribbon supply (not shown). Alternatively, other types of printing such as direct thermal printing a thermal print head 30 directly contacts the printable surface 16 of the label, thus, triggering a chemical or physical change in a thermally sensitive dye covering at least a portion of the printable surface 16 of the label.

In either thermal transfer printing or direct thermal printing applications, the web of linerless label media 15 is routed from the supply roll 12 to a print position located beneath the thermal print head 30. Idler rollers 14, spring biased dancers, and other similar devices may be provided to manipulate the linerless label media 15 through the printer. These devices are generally designed to contact only the printable surface 16 of the linerless label media 15 as shown, thereby reducing the likelihood that the idler rollers or other devices will adhere to the adhesive surface 18 of the label media. Any such adhesion may undesirably bind or jam the printer.

The continuous web of linerless label media 15 is pulled through the printer system 10 by a platen roller 20 that is often powered by a stepper motor (not shown). Typically, the linerless label supply 12 is moderately biased to oppose the driving force produced by the platen roller 20. More particularly, the label supply 12 is generally biased to resist removal of the label media 15 from the label supply 12 by a fractioning device, clutch or other similar mechanism (not shown). This bias maintains tension in the web of linerless label media 15 as it is pulled through the printer by the platen roller 20. Unlike idler rollers 14, the platen roller 20 is designed to contact the adhesive surface 18 of the linerless label media 15 as shown. To prevent adhesion between the platen roller 20 and the linerless label media 15, the platen roller 20 includes an adhesive release coating such as silicone, plasma coating, or other similar materials known in the art.

In various prior art applications, the print head 30 is positioned immediately above the platen roller 20. In fact, the print head 30 is generally configured to pinch the linerless label 15 between the print head 30 and the apex of the platen roller 20 as shown. This pinching or compressive force provides adequate print quality and in some applications ensures that a sufficient tension is maintained along the continuous web of linerless label media 15. Once printed, the printed portion of the linerless label is advanced outwardly by the platen roller 20 to extend over a tear bar 35 as shown. The printed linerless label remains cantilevered over the tear bar 35 until removed by a user. In some applications, a sensor is positioned adjacent the tear bar 35 to detect the removal of the printed linerless label. In the depicted application, the sensor is a light sensor including an emitter 32 and a receiver 34. The emitter transmits a beam of light upwardly toward the receiver 34, which is positioned generally adjacent the print head 30 as shown. If a printed label has been removed the beam of light reaches the receiver 34, if not, the beam of light is blocked. In this regard, the printer processor may determine for subsequent print registration whether a printed label is awaiting removal or has already been removed.

Unfortunately, in a variety of circumstances printed labels remain in the removal position for a prolonged period of time. In conventional printers, this removal delay can be problematic because the labels generally lack the rigidity or stiffness to remain cantilevered for this extended period of time. Accordingly, the linerless labels tend to sag or droop. This sagging is exacerbated by the weight of the label, environmental conditions such as humidity, and any residual bends previously developed by the linerless label during storage on the wound supply roll 12. In various applications, the sagging of printed linerless labels may result in damage or folding of the label, contamination of the adhesive surface of the label as it sags against external printer components, and undesirable jamming of the printer.

### BRIEF SUMMARY OF THE INVENTION

The present invention provides an improved linerless label printer and an associated method for printing a linerless label wherein the printed label is supported in a cantilevered position by a blanket of air until removal. As referenced above, linerless labels are those labels that are printed and used without conventional release paper or liners. The labels include a printable surface and an opposed adhesive surface. In one embodiment of the present invention, a linerless label printer is provided, comprising: a platen roller for driving the linerless label from a print position to a removal position, print head for printing the linerless label in the print position, and a flow device for providing a low-pressure air flow that buoyantly supports the linerless label in a generally cantilevered orientation in the removal position.

In another embodiment of the present invention, a linerless label printer is provided, comprising: a platen roller for driving the linerless label from a print position to a removal position, a secondary roller disposed adjacent the platen roller for removing a partially-adhered linerless label from the platen roller, and a flow device for providing a low-pressure air flow that buoyantly supports the linerless label generally above the secondary roller in the removal position.

In one embodiment, the flow device is an exhaust fan. In another embodiment, the flow device is a fan dedicated solely to supporting the linerless label in the removal position. In another embodiment, the flow device is positioned generally below the linerless label and is directed generally upwardly to buoyantly support at least a portion of the linerless label in the removal position. In various other embodiments, one or more ducts, deflectors, or other similar devices are included to direct the air flow from the flow device to the printed linerless label and buoyantly support the label in the removal position. In still other embodiments, the linerless label printer includes a tear bar positioned generally above the printable surface of the linerless label in the removal position. In another embodiment, the linerless label printer includes a label sensor positioned generally above the linerless label in the removal position.

In another embodiment, a method of operating a printer is provided. The method comprises the steps of: advancing a linerless label via a platen roller from a print position to a removal position, the linerless label having a printable surface and an opposed adhesive surface; and buoyantly supporting the linerless label in a generally cantilevered orientation via a low-pressure air flow directed to contact the adhesive surface of the linerless label. In one embodiment, the linerless label is buoyantly supported in a generally cantilevered orientation above a secondary roller that is positioned adjacent the platen roller. In yet another embodiment, the method further comprises the step of securing a tear bar above the linerless label in the removal position.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic illustration of a linerless label printer according to the known prior art;

FIG. 2 is a schematic illustration of a linerless label printer according to one embodiment of the invention, wherein the linerless label is illustrated in a registration position;

FIG. 3 is a schematic illustration of a linerless label printer according to one embodiment, wherein the linerless label is configured in a print position;

FIG. 3A is a detail view of the linerless label printer of FIG. 3, taken along Detail Circle 3A of FIG. 3;

FIG. 4 is a schematic illustration of a linerless label printer according to one embodiment, wherein the linerless label is configured in an advancing position between the print position and the removal position;

FIG. 4A is a schematic illustration of a linerless label printer according to another embodiment, wherein the linerless label is configured in an advancing position between the print position and the removal position; and

FIG. 5 is a schematic illustration of a linerless label printer according to one embodiment of the invention, wherein the printed linerless label is buoyantly supported in the removal position by a flow device.

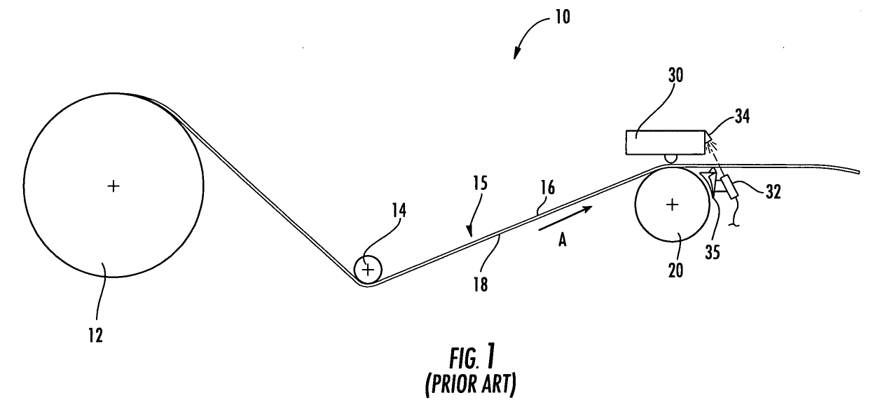

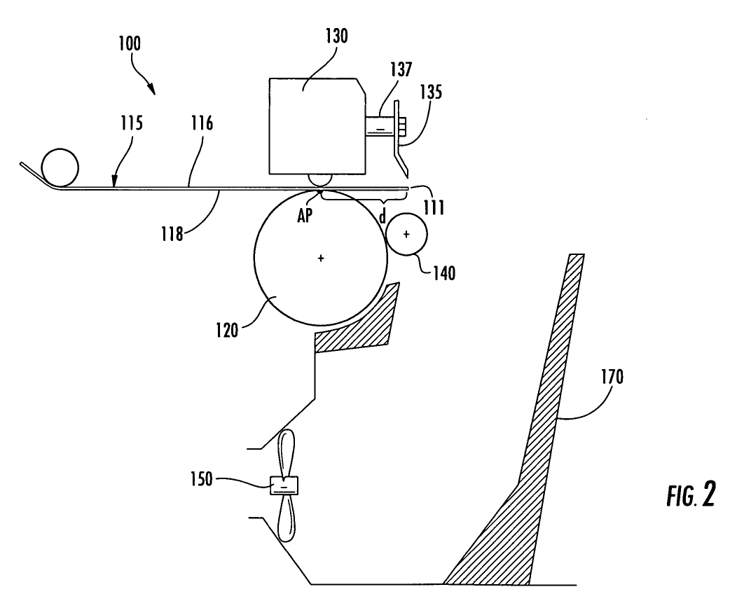

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

FIG. 2 is a schematic representation of a printer 100 for printing linerless labels in accordance with one embodiment of the present invention. As will be apparent to one of ordinary skill in the art, the printer 100 includes a support shaft for receiving a linerless label supply (not shown). The linerless label supply generally consists of a wound roll of continuous linerless label media 115. The linerless label media 115 includes a printable surface 116 opposed by an adhesive surface 118 that is coated at least partially with a pressure sensitive adhesive. Unlike more conventional labels, linerless labels 115 do not have a release layer or liner covering their adhesive surface 118 that protects the label from pre-mature adhesion or contamination. Accordingly, in order to be usably wound on a supply spool, the printable surface 116 of the label media 115 is generally coated with silicone or other similar materials so that the supply roll layers do not stick together.

In various embodiments of the present invention, the continuous web of linerless label media 115 is threaded through the printer 100 between a linerless label supply roll (not shown) and a platen roller 120. The linerless label supply is biased to resist being drawn through the printer, thereby ensuring adequate tension remains in the label media throughout subsequent printing and backfeed processes. Depending upon the application, as known to one of ordinary skill in the art, the linerless label media 115 is threaded automatically or manually during loading. The platen roller 120 is configured to rotate in either direction for driving the linerless label 115 between various positions (e.g., registration position, print position, removal position, etc.). Unlike idler rollers or other tensioning devices that contact only the printable surface 116 of the label, the platen roller 120 is designed to contact the adhesive surface 118 of the label as shown. As a result, the platen roller 120 is coated with adhesive release materials such as silicone, plasma coating, or other similar materials known in the art. Typically, the platen roller 120 is powered by one or more stepper motors (not shown) and controlled by a printer processor as discussed further below.

A print head 130 is generally provided above the platen roller 120 for printing an image to the linerless label media 115. As described above, the print head 130 engages and moderately compresses the linerless label 115 into the platen roller 120. This compression enhances print quality and in some applications maintains a sufficient tension along the linerless label web 115. Although not required, the print head 130 generally engages the platen roller 120 adjacent its apex as shown. For the purposes of the present invention and appended claims, the engagement position between the print head 130 and the platen roller 120 will be referred to as a print point. Similar to the platen roller above, the movement and operation of the print head 130 is controlled by the printer processor (not shown).

To print a batch of labels, an operator selects the indicia to be printed in addition to various label parameters such as format, quantity, etc. The processor receives this input from an interface (not shown) and engages the platen roller 120 and print head 130 to carry out the operator's requested print job. However, before the print job is carried out, the linerless label media 115 is typically advanced to a known registration position such as that depicted in FIG. 2. From this known position, the area of the label to be printed can be properly aligned with the leading edge 111 of the media 115, or perhaps a perforation, in order to reduce waste. Upon occurrence of a trigger condition such as loading a label supply into the printer, providing power to the printer, closing the printer housing, etc., the linerless label 115 is typically advanced to a position whereby the leading edge of the linerless label is positioned beyond the print point and the printer detects (generally through an optical sensor or the like) a registration mark disposed on the linerless label media 115. The platen roller 120 then reverses the linerless label media 115 a known distance until reaching a selected registration position. In other applications, as will be apparent to one of ordinary skill in the art, an optical sensor (not shown) may be disposed upstream of the platen roller such that linerless media is advanced, rather than reversed, to a selected registration position upon detection of the media registration mark.

In the depicted embodiment, the registration position is a preset position wherein the leading edge 111 of the linerless label is spaced a distance d from the print point defined above between the print head 130 and the platen roller 120. The depicted registration position is set such that the leading edge 111 of the media is generally aligned with a tear bar 135 or other cutting device such that the media 115 is automatically disposed in the registration position upon removal of a printed label by an operator. Notably, other methods of registration are commonly known in the art and the inventive concepts herein described are not limited to any one method of registration.

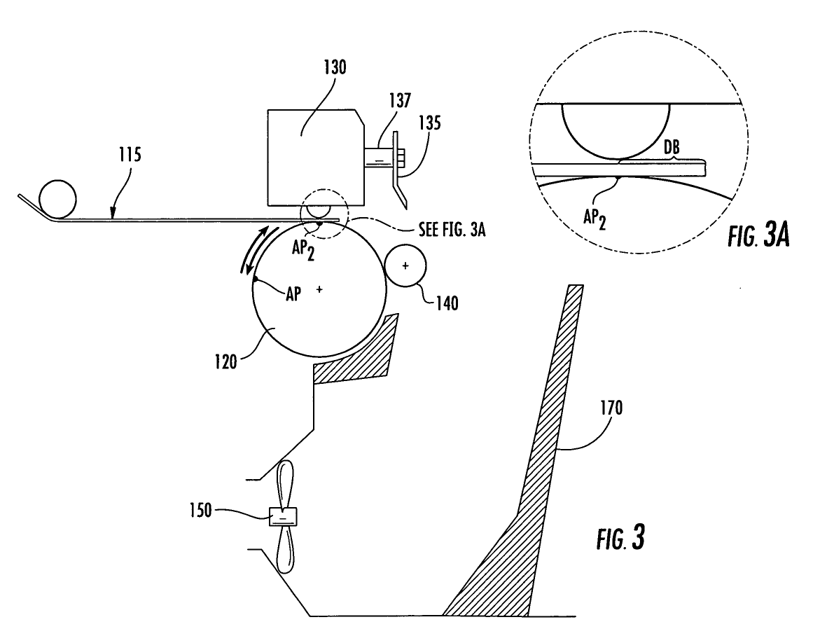

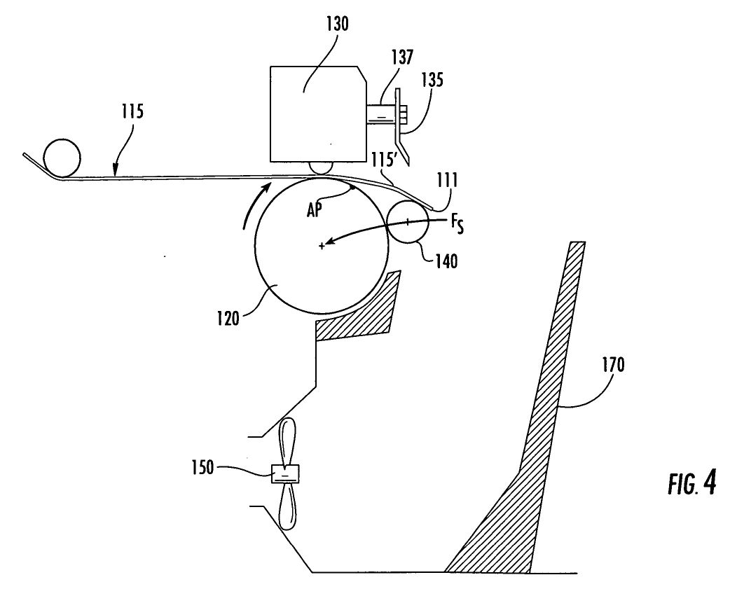

If a print job is not imminent, the linerless label media 115 may remain in the registration position for a period of time. In the depicted embodiment, as noted above, the registration position is calibrated with the desired label length such that the leading edge of the label is positioned generally under the tear bar as shown. In relatively new printers, this registration position delay may not cause difficulty; however, in heavily used printers where the no-stick characteristics of the platen roller 120 has begun to wear out, this delay may cause partial adhesion between the linerless label 115 and the platen roller 120 at adhesion point AP. Immediately prior to printing, this adhesion is dislodged by a backfeed operation wherein the platen roller 120 abruptly reverses the linerless label media 115 to a print position illustrated in FIG. 3. In the print position, the leading edge 111 of the linerless label media 115 is generally positioned adjacent to, or just downstream from, the print point defined between the print head 130 and platen roller 120. As a result, individual labels are accurately printed onto the web of linerless label media 115 with relatively little wasted material. In the depicted embodiment, the leading edge 111 of the linerless label media is positioned a distance DB downstream of the print position as shown in the detail view provided by FIG. 3A. This distance DB is commonly referred to as a “dead band” and may operate to reduce the likelihood that the leading edge of the linerless label will adhere to the platen as will be apparent to one of ordinary skill in the art. In various embodiments, the distance may be less than 0.75 inches, preferably less than 0.5 inches, and more preferably approximately 0.2 inches.

Upon reaching the print position, it is desirable for the print head 130 to begin printing and for the linerless label 115 to simultaneously begin its advance. The relatively prompt advancement of the linerless label 115, which is driven by the platen roller 120, reduces the likelihood that a second adhesion point AP₂ will form between the linerless label 115 and the platen roller 120 as shown in FIG. 3. If left to develop, this second adhesion point AP₂ could cause the printed linerless label to wrap around the platen roller 120, thus, jamming the printer.

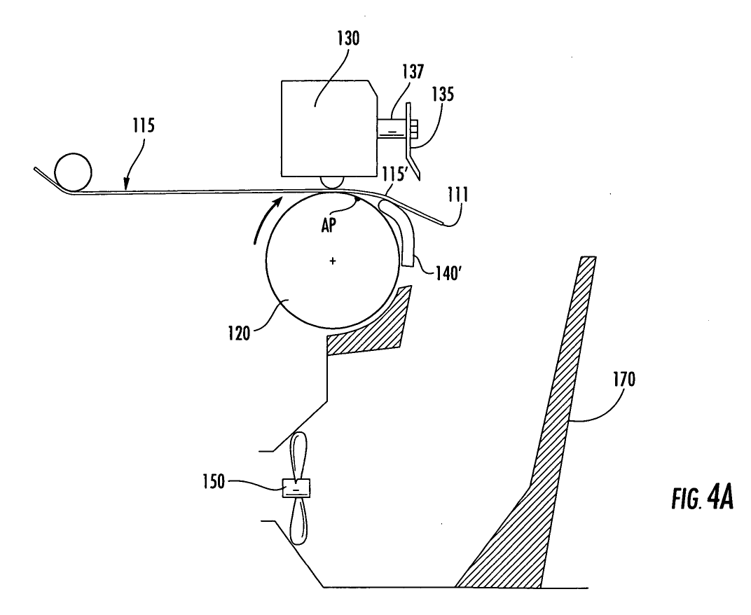

As the platen roller 120 drives the label media 115 forward during printing, adhesive residue proximate the adhesion point AP remaining on the platen roller 120 or previously disturbed adhesive on the media itself may cause the printed linerless label 115′ to advance slightly downwardly around the platen roller 120 as depicted in FIG. 4. Additional adhesion possibly occurring at AP₂ may also cause the media to advance slightly downward. Notably, any dead band DB provided during printing aids in preventing adhesion between the platen roller 120 and the leading edge 111 of the label media and, thus, the leading edge 111 of the printed label 115′ remains spaced from the platen 120 as shown.

In some embodiments, to prevent further wrapping of the linerless label 115, a secondary roller 140 may be provided adjacent the platen roller 120 as shown. The secondary roller 140 may be formed from a polymer, wood, rubber, metal, or other similar materials. For example, the secondary roller may be comprised of a Tetrafluoroethylene (“TFE”) material such as Rulon®. In the depicted embodiment, the secondary roller 140 is considerably smaller in diameter than the platen roller 120. In some embodiments, the secondary roller 140 may be configured to approach the platen roller 120 without adversely contacting or obstructing the rotation of the platen roller 120. The depicted secondary roller 140 is biased along force direction Fₛ to lightly contact the platen roller 120 and is thus designed to rotate with the platen roller 120.

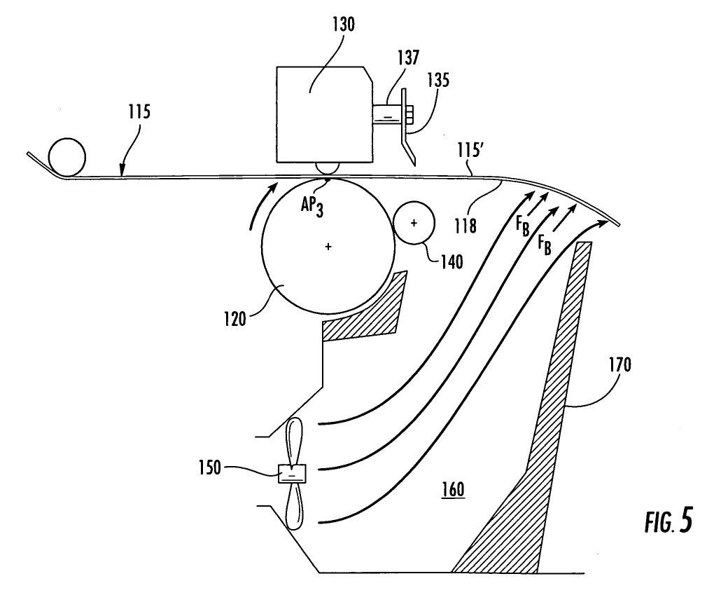

As the printed linerless label 115′ is advanced by the platen roller 120, the leading edge 111 of the printed label 115′ may extend over the secondary roller 140. In one embodiment, the periphery of the secondary roller 140 is coated with non-stick materials of the type described above, which prevent adhesion between the printed linerless label 115′ and the secondary roller 140. Other adhesion reducing techniques known in the art may be used such as structuring the secondary roller 140 to have a scalloped periphery. As the printed linerless label 115′ advances over the secondary roller 140, the rotation of the platen roller 120 and the relative stiffness of the printed label 115′ mechanically dislodge adhesion occurring between the linerless label 115 and platen roller 120. As a result, the printed linerless label 115′ is free to extend generally horizontally from the platen roller 120 in a removal position as illustrated in FIG. 5.

As noted above, the depicted secondary roller 140 is spring biased to lightly contact the platen roller 120. In such embodiments, the secondary roller 140 may be moved against its position bias (e.g., spring tension, etc.) away from the platen roller 120 in a direction generally opposite to arrow Fₛ. This mobility allows for an operator to conveniently access the platen roller 120 in the event of platen malfunction and/or other printer servicing.

In yet another embodiment of the present invention, the secondary roller may be replaced by other adhesion detaching structures such as the bumper 140′ shown in FIG. 4A. The bumper 140′ may be comprised of a flexible polymer, rubber, or other similar material. The bumper 140′ may define a textured surface and may be coated with silicone oil or other similar non-stick coatings. In the depicted embodiment, the bumper 140′ defines an arcuate shape as shown. However, other shapes may be adopted to perform the adhesion detaching function described herein as will be apparent to one of ordinary skill in the art in view of this disclosure. In one embodiment, the bumper 140′ may define a vertically scalloped exterior surface that is structured to reduce the surface area of the bumper 140′ that actually contacts the linerless media 115 and thereby reduces the potential for adhesion between the bumper 140′ and the linerless media 115. In various embodiments, the bumper 140′ may be coated with non-stick materials of the type described above.

As described above with regard to the secondary roller, the bumper 140′ may be spring biased to lightly contact the platen roller 120. In this regard, the bumper 140′ may be moved against its position bias (e.g., spring tension, etc.) away from the platen roller 120 in a direction generally opposite to arrow Fₛ (of FIG. 4). This mobility allows for an operator to conveniently access the platen roller 120 in the event of platen malfunction and/or other printer servicing. In other embodiments, this mobility may be provided by or enhanced by a bumper 140′ comprised of flexible or elastic materials. As will be appreciated by one of ordinary skill in the art, bumpers structured in accordance with various embodiments of the invention may be positioned relatively close to the print head thereby allowing a reduction in dead band length.

In another embodiment of the present invention, the printed linerless label 115′ is buoyantly supported in this generally cantilevered or extended orientation in the removal position by an air flow 155 produced by a flow device 150. Accordingly, the problems discussed above that are associated with conventional linerless label printers, e.g., drooping or sagging of the printed linerless label 115′ in the removal position, are thus overcome.

Unlike conventional air knives, which direct a high-pressure stream of air (typically between 20-50 p.s.i.) between a printed linerless label and the platen roller to dislodge adhesion occurring therebetween, the present invention provides a flow device 150 that directs a low-pressure flow of air upwardly from the flow device 150 to buoyantly support a printed linerless label 115′ in a generally cantilevered removal position. In various embodiments, the low-pressure flow of air is between 0-5 p.s.i, preferably between 0-2 p.s.i., and more preferably less than 1 p.s.i. At such pressures, the printed linerless label is buoyantly supported in a substantially cantilevered or extended removal position and, thus, may be readily sensed by a label retrieval sensor (e.g., optical sensor, etc.) and easily removed by an operator. For purposes of the present specification and appended claims the term “cantilevered or extended” orientation refers a linerless label position whereby the linerless label is supported at a proximal end by printer components (e.g., platen roller, etc.) and supported at a distal end only by the low pressure flow produced by the flow device.

As will be apparent to one of skill in the art, conventional high pressure air knives are not desirable in the structure adapted by various embodiments of the present invention as such devices would produce a high pressure air stream that could fold or otherwise damage the printed linerless label 115′. High pressure air knives would likely also prevent the label from being properly substantially horizontally presented to the operator and could possibly injure the operator by hurling loose particulate upwardly, toward the operator, at relatively high speeds. Further, high pressure air streams may drive the printed label 115′ severely upwardly to jam against components secured above the printed label 115′ such as the depicted tear bar 135.

In one embodiment of the present invention, the flow device 150 may be an exhaust fan that is traditionally used to cool various internal printer components. In other embodiments, a fan dedicated solely to printed label support (not shown) may be used. In still other embodiments, low-pressure air jets, low-pressure pneumatic cylinders or other similar devices structured to produce a low-pressure flow of air or other gases for buoyantly supporting a linerless label may be used. In one embodiment, the printer 100 includes a channel 160 that directs the air flow 155 produced by the fan 150 upwardly, toward the adhesive surface of the printed linerless label 115′ as shown in FIG. 5. The channel 160 route may be defined, at least partially, by one or more deflectors 170 as shown. In various embodiments, the deflectors 170 may include standard pieces, such as portions of the external housing of the printer, or alternatively, may include specifically designed shrouds, chambers or ramps positioned adjacent the fan 150 for deflecting the air flow 155 toward the printed portion of the linerless label 115′. Further, in other embodiments, one or more air ducts or hoses (not shown) may be provided to route the air flow 155 from any position within the printer as will be apparent to one of ordinary skill in the art. Accordingly, the fans or flow devices 150 may be strategically positioned in a variety of locations within the printer based on other design considerations and need not be positioned generally below the platen roller 120 as shown.

In other embodiments, various conventional printer components may be relocated to a position above the printed linerless label 115′ for reducing possible obstruction of the upwardly directed air flow 155. For example, in one embodiment, a tear bar 135 is relocated from a conventional position below the linerless label 115′ to a position above the label 115′. The tear bar 135 provides an edge for assisting an operator to uniformly tear a printed label 115′ from the web of linerless label media 115. As will be apparent to one of ordinary skill in the art, an operator removes the printed linerless label 115′ by grasping the label and pulling upwardly against the tear bar 135. In various embodiments, the linerless label 115′ may include one or more perforations that are alignable with the tear bar 135 such that the label may be removed in an efficient and uniform fashion. By placing the tear bar 135 above the printed linerless label 115′, rather than below, the tear bar 135 and its support structures do not obstruct the free flow of air to the printed linerless label 115′. In other embodiments, label sensors (not shown) and other similar components may be removed from beneath the printed linerless label 115′ as will be apparent to one of ordinary skill in the art in view of the above disclosure.

In still another embodiment, the tear bar 135 is supported a distance downstream of the print position by a tear bar extension 137. In various embodiments, linerless label printers may be configured as “on-demand” printers wherein individual labels are printed as they are retrieved by an operator. Thus, the printed linerless labels 115′ are prone to resting for prolonged intervals in the removal position illustrated in FIG. 5. As described above, such rest periods may cause partial adhesion between the linerless label media 115 and the platen roller 120 at adhesion point AP₃. By positioning the tear bar 135 a distance downstream of the print position, the label media 115′ is properly positioned for a robust backfeed operation to occur once the printed linerless label 115′ has been removed or otherwise when desired. As will be apparent to one of ordinary skill in the art, this backfeed operation is generally similar to that described above with regard to registration of the linerless label media 115. Although various embodiments referenced above have been described and depicted employing a tear bar, additional embodiments may use a similarly oriented cutter or other similar device as will be apparent to one of ordinary skill in the art in view of the above disclosure.

Still another embodiment of the present invention is directed to a back-winding media supply spindle. As noted above, conventional linerless printers may employ a frictioning device to bias the printer's media supply against forward motion or advancement of the linerless media by the platen roller. This biasing against forward motion helps to deter the linerless printing media from un-winding excessively, sagging, and adhering in the printer's internal media path.

Unlike conventional frictioning devices that simply oppose forward motion of the media supply (i.e., unwinding of the media from the supply), the back-winding media supply spindle applies a relatively continuous back tension of approximately 300 to 500 grams to the media web between the media supply roll and the platen/print head nip. In one embodiment, this tension is present during forward movement of the media, during backward movement of the media (i.e., during backfeed), and while the media is at rest. This tension may prevent the linerless media from sagging and adhering to the printer's internal media path. In contrast to prior art devices, the back-winding media supply spindle may also operate in conjunction with a robust back feed (e.g., a backfeed distance of approximately 0.5 inches or greater) to physically break adhesion that may have developed between the linerless media and the platen at location AP (shown in FIG. 2).

As will be apparent to one of ordinary skill in the art, without the disclosed back-winding media supply spindle, the linerless media may remain adhered at location AP and, thus, simply back-wrap around the platen roller during backfeed operations. Should this occur, the media may remain adhered to the platen roller through the printer's subsequent forward printing motion and may increase the chance that the linerless media will be drawn forwardly around the platen thereby jamming the printer.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A printer for printing a linerless label having a printable surface and an opposed adhesive surface, the printer comprising:
a platen roller for driving the linerless label from a print position to a removal position; and
a flow device structured to provide a low-pressure flow that buoyantly supports the linerless label in a cantilevered orientation in the removal position.

2. The printer of claim 1, wherein the low-pressure flow is provided at less than 5 pounds per square inch.

3. The printer of claim 1, wherein the low-pressure flow is provided at less than 2 pounds per square inch.

4. The printer of claim 1, wherein the low-pressure flow is provided at less than 1 pound per square inch.

5. The printer of claim 1, further comprising a secondary roller disposed immediately downstream from the platen roller for dislodging the printed linerless label from the platen roller.

6. The printer of claim 1, further comprising a bumper disposed immediately downstream from the platen roller for dislodging the printed linerless label from the platen roller.

7. A printer for printing a linerless label having a printable surface and an opposed adhesive surface, the printer comprising:
a platen roller for driving the linerless label from a print position to a removal position; and
an adhesion detaching structure disposed immediately downstream of the platen roller that is capable of contacting a protruding portion of the linerless label and thereby dislodging any residual adhesion occurring between the linerless label from the platen roller.

8. The printer of claim 7, wherein the adhesion detaching structure is a secondary roller.

9. The printer of claim 7, wherein the adhesion detaching structure is a bumper.

10. The printer of claim 7, wherein the adhesion detaching structure is biased against a downstream portion of the platen roller.

11. The printer of claim 7, further comprising a cutting device positioned a distance downstream of the print position, wherein the cutting device is structured to sever a portion of the linerless label upon being disposed in the removal position.

12. The printer of claim 11, wherein the platen roller is further adapted to reverse the linerless label from the removal position to the print position, thereby dislodging adhesion that may have occurred between the linerless label and the platen roller in the removal position.

13. The printer of claim 7, wherein the linerless label defines a leading edge, the platen roller defines an apex, and wherein the leading edge of the linerless label is disposed a dead band distance downstream of the apex of the platen roller in the print position.

14. The printer of claim 13, wherein the dead band distance is less than 0.75 inches.

15. The printer of claim 13, wherein the dead band distance is approximately 0.2 inches.

16. The printer of claim 7, further comprising a flow device structured to provide a low-pressure flow that buoyantly supports the linerless label in a cantilevered orientation in the removal position.

17. The printer of claim 16, wherein the flow device is a fan structured to provide the low-pressure flow of air that buoyantly supports the linerless label in a cantilevered orientation in the removal position.

18. The printer of claim 17, wherein the fan is positioned generally below the linerless label, and wherein the printer further comprises at least one deflector for deflecting the low-pressure flow of air produced by the fan generally upwardly to buoyantly support at least a portion of the linerless label in the removal position.

19. A printer for printing a linerless label having a printable surface and an opposed adhesive surface, the printer comprising:
a platen roller for driving the linerless label from a print position to a removal position;
an adhesion detaching structure disposed immediately downstream of the platen roller for contacting a protruding portion of the linerless label and thereby dislodging any residual adhesion occurring between the linerless label from the platen roller; and
a flow device providing a low-pressure flow that buoyantly supports the linerless label in a cantilevered orientation in the removal position.

20. The printer of claim 19, wherein the adhesion detaching structure is a secondary roller.

21. The printer of claim 19, wherein the adhesion detaching structure is a bumper.

22. A method of operating a printer, comprising the steps of:
advancing a linerless label via a platen roller from a print position to a removal position, the linerless label having a printable surface and an opposed adhesive surface;
detaching residual adhesion occurring between the adhesive surface of the linerless label and the platen roller as the linerless label is advanced to the removal position; and
buoyantly supporting the linerless label in a cantilevered orientation in the removal position via a low-pressure flow directed to contact the adhesive surface of the linerless label.
